(19) United States
(12) Patent Application Publication
(10) Pub. No.: US 2014/0331259 A1
(43) Pub. Date: Nov. 6, 2014

(54) APPARATUS AND METHOD FOR RECEIVING DIGITAL BROADCAST

(71) Applicant: Samsung Electronics Co., Ltd, Suwon-si, Gyeonggi-do (KR)

(72) Inventor: Katsunori Araki, Yokohama-si (JP)

(73) Assignee: Samsung Electronics Co., Ltd., Suwon-si, Gyeonggi-do (KR)

(21) Appl. No.: 14/364,538

(22) PCT Filed: Dec. 14, 2012
(86) PCT No.: PCT/KR2012/010884

§ 371 Date: Jun. 11, 2014

(30) Foreign Application Priority Data
Dec. 14, 2011 (JP) 2011-273696

(51) Int. Cl. H04H 60/70; H04N 21/431; H04N 21/258; H04H 60/49

(52) U.S. Cl. CPC H04H 60/70; H04H 60/49; H04N 21/431; H04N 21/25891
USPC 725/34

(57) ABSTRACT

There is provided a digital broadcast receiving apparatus for recommending a program to sufficiently reflect a user's taste based on capturing position information of a still image.

The digital broadcast receiving apparatus includes a still image additional information interpreting unit 13 for collectively determining a priority for a capturing position of a read still image, a program place name information interpreting unit 24 for extracting a keyword that specifies a geographical position or a range such as a place name and a landmark name from program information, a position overlap evaluating unit 33 for obtaining a map range corresponding to the extracted keyword with reference to map information on the geographical position and the range of the place name or the landmark and evaluating a degree of overlap between the map range and a capturing position range having a predetermined priority, a recommended program interpreting unit 34 for setting a priority for a program including the keyword to which the map range corresponds when the degree of overlap is larger than a predetermined value, and a recommended program notifying unit 35 for generating a user interface for recommending the program for which the priority is set to be high.

### TECHNICAL FIELD

The present invention relates to a digital broadcast receiving apparatus, and more particularly, to digital broadcast receiving apparatus and method for recommending a program that suits a user's taste based on capturing position information of still images.

### BACKGROUND ART

With multi-channelization of a television broadcast, digital broadcast receiving apparatuses (TV apparatuses) with a function of guessing users' tastes from various points of view to recommend programs are suggested and commercialized. On the other hand, with digitalization of various media, music may be reproduced or still images may be displayed by the TV apparatuses. In addition, most TV apparatuses have a common function of reading or storing still images.

Users are considered to have strong interests in the still images read from or stored in the TV apparatuses. Therefore, geographical positions in which the still images are captured are considered as one of information items in which the users are interested. Therefore, a TV apparatus for recommending a program based on capturing position information of still images is developed (for example, refer to Patent Documents 1 and 2).

### PRIOR ART DOCUMENTS

Patent Document 1: International Patent Publication No. 2008/129879
Patent Document 2: Japanese Patent Publication No. 2009-272836

### DETAILED DESCRIPTION OF THE INVENTION

### Technical Problem

In a conventional TV apparatus, since position information obtained from program information and capturing position information of still images are combined by simply searching place names, priorities for capturing positions of the still images are not set. Therefore, program recommendation based on the capturing position information of the still images may not sufficiently reflect a user's taste.

The present invention provides a digital broadcast receiving apparatus for recommending a program to sufficiently reflect a user's taste based on capturing position information of still images.

### Technical Solution

According to an aspect of the present invention, there is provided a digital broadcast receiving apparatus capable of reading a still image captured by a digital still camera, including a still image additional information interpreting unit for collectively determining a priority for a capturing position of a still image based on additional information on the still image, a program place name information interpreting unit for extracting a keyword that specifies a geographical position or a range from program information of a digital broadcast, a position overlap evaluating unit for obtaining a map range corresponding to the extracted keyword with reference to map information on the geographical position and the range and evaluating a degree of overlap between the map range and a capturing position range having a predetermined priority which is predetermined by the still image additional information interpreting unit, a recommended program interpreting unit for setting a priority for a program including the keyword to which the map range corresponds when the degree of overlap is larger than a predetermined value, and a recommended program notifying unit for generating a user interface for recommending the program for which the priority is set.

Therefore, the priority for the capturing position of the read still image is collectively determined and a priority for a program is set to be high in accordance with a ratio of a degree of overlap between a capturing position range having a predetermined priority and a map range corresponding to a keyword extracted from program information. Therefore, it is possible to recommend a program to sufficiently reflect capturing position information of a still image.

The recommended program interpreting unit may set a priority for a program to be higher as a map range to be evaluated by the position overlap evaluating unit becomes smaller. The recommended program interpreting unit may set a priority for a program to be higher as the predetermined priority determined by the still image additional information interpreting unit for a capturing position range to be evaluated by the position overlap evaluating unit becomes higher.

The digital broadcast receiving apparatus may further include a map information obtaining unit for accessing a network to obtain the map information.

The recommended program notifying unit may link program information of a program having a high priority to a map image by the user interface to generate a program map. The priority for the capturing position determined by the still image additional information interpreting unit may be displayed to be gradated and overlapped on the program map on the program map.

### Advantageous Effects

According to the present invention, a program may be recommended to sufficiently reflect a user's taste based on capturing position information of still images.

### DESCRIPTION OF THE DRAWINGS

FIG. 1 is a block diagram of main portions of a digital broadcast receiving apparatus according to an embodiment of the present invention;

FIG. 2 is a block diagram illustrating that a capturing position distribution chart is generated from a set of capturing positions of still images;

FIG. 3 is a block diagram illustrating an example of evaluation of an overlap area between a map range based on program information and a horizontal cross-section of a capturing position distribution chart;

FIG. 4 is a view illustrating an example in which a program map is displayed on a screen; and

FIG. 5 is a view illustrating an example in which an enlarged program map is displayed on a screen.

### BEST MODE

A digital broadcast receiving apparatus according to an embodiment of the present invention includes a still image additional information interpreting unit for collectively determining a priority for a capturing position of a still image based on additional information on the still image, a program place name information interpreting unit for extracting a keyword that specifies a geographical position or a range from program information of a digital broadcast, a position overlap evaluating unit for obtaining a map range corresponding to the extracted keyword with reference to map information on the geographical position and the range and evaluating a degree of overlap between the map range and a capturing position range having a predetermined priority which is predetermined by the still image additional information interpreting unit, a recommended program interpreting unit for setting a priority for a program including the keyword to which the map range corresponds when the degree of overlap is larger than a predetermined value, and a recommended program notifying unit for generating a user interface for recommending the program for which the priority is set.

A digital broadcast receiving method according to an embodiment of the present invention includes collectively determining a priority for a capturing position of a still image based on additional information on the still image, extracting a keyword that specifies a geographical position or a range from program information of a digital broadcast, obtaining a map range corresponding to the extracted keyword with reference to map information on the geographical position and the range and evaluating a degree of overlap between the map range and a capturing position range having a predetermined priority, setting a priority for a program including the keyword to which the map range corresponds to be high when the degree of overlap is larger than a predetermined value, and generating a user interface for recommending the program for which the priority is set to be high.

### MODE OF THE INVENTION

Hereinafter, an embodiment of the present invention will be described with reference to the accompanying drawings. The present invention is not limited to the following embodiment.

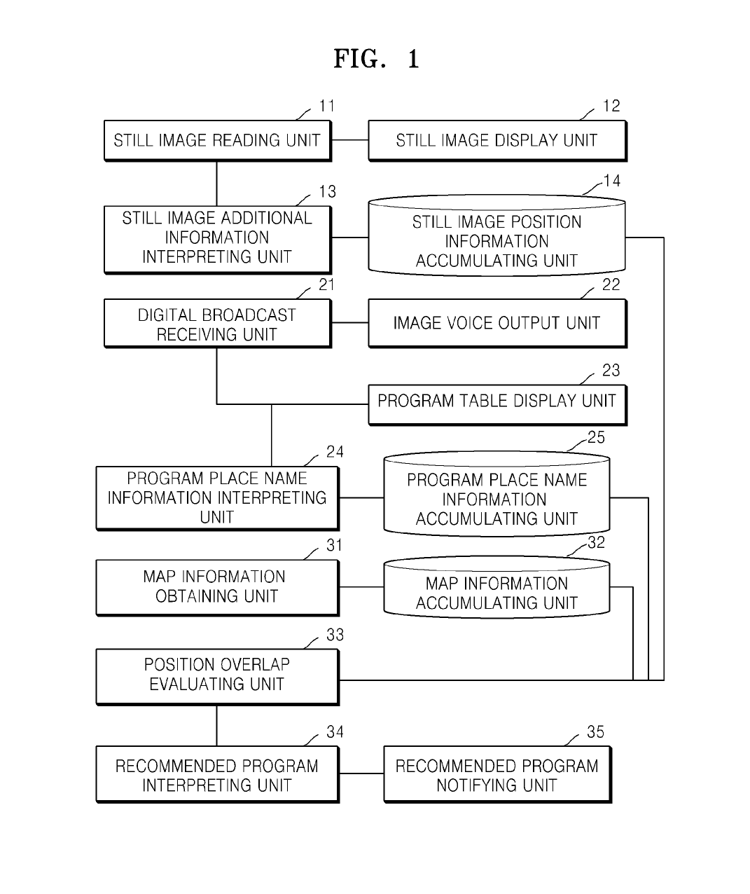

FIG. 1 is a block diagram of main portions of a digital broadcast receiving apparatus according to an embodiment of the present invention. The digital broadcast receiving apparatus according to the embodiment of the present invention includes a still image reading unit 11, a still image display unit 12, a still image additional information interpreting unit 13, a still image position information accumulating unit 14, a digital broadcast receiving unit 21, an image voice output unit 22, a program table display unit 23, a program place name information interpreting unit 24, a program place name information accumulating unit 25, a map information obtaining unit 31, a map information accumulating unit 32, a position overlap evaluating unit 33, a recommended program interpreting unit 34, and a recommended program notifying unit 35. The digital broadcast receiving apparatus interprets capturing positions of still images read or stored by a user to recommend a broadcast program that suits a user's taste. In addition, the still image additional information interpreting unit 13, the program place name information interpreting unit 24, the map information obtaining unit 31, the position overlap evaluating unit 33, the recommended program interpreting unit 34, and the recommended program notifying unit 35 may be implemented by one of hardware and software.

The still image reading unit 11 reads captured still images by a digital still camera. The still images may be read from media such as a secure digital (SD) card and a compact disc read only memory (CD-ROM) or communications such as wired and wireless local area networks (LAN) and Bluetooth (a registered trademark). The still image display unit 12 displays the read still images.

The still image additional information interpreting unit 13 collectively determines the capturing positions of the still images based on additional information on the read still images. Corresponding priorities may be represented by, for example, a capturing position distribution chart. As described above, still images captured by the digital still camera commonly have additional information represented by an exchangeable image file format (Exif). A capturing date, a capturing device model name, resolution, and a focal distance are included in the additional information. In addition, in still images captured by a digital still camera with a global positioning system (GPS) function, information on capturing positions (latitudes and longitudes) and azimuth is recorded. The still image additional information interpreting unit 13 generates a capturing position distribution chart based on, for example, the additional information including the information on the capturing positions illustrated in TABLE 1.

TABLE 1

| Capturing | | | | | Focal | Capturing |
|---|---|---|---|---|---|---|
| date | Longitude | Latitude | Azimuth | Resolution | distance | device |
| 2011 May 18 | 35.7119 | 139.8023 | 36.26 | 400px | 55.2 mm | Sony X |
| 17:35:20 | | | degrees | | | |
| 2011 Jul. 25 | 35.7099 | 139.8106 | 165.23 | 800px | 18.2 mm | Nikon X |
| 17:35:20 | | | degrees | | | |

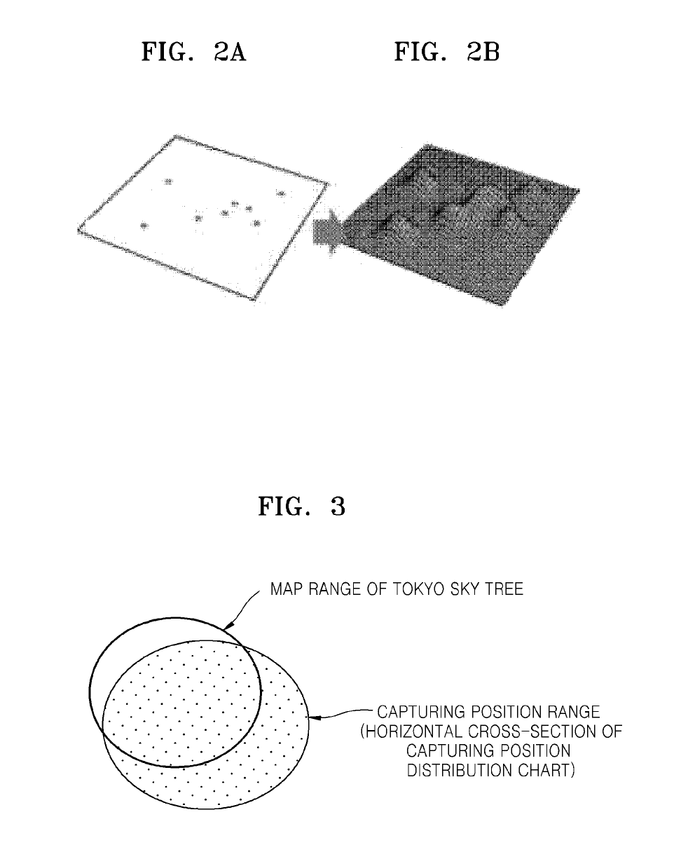

The capturing position distribution chart may be generated by arranging the capturing positions of the still images on a map. Specifically, the respective capturing positions have certain heights (altitudes) and ranges in accordance with Kernel density estimation in two variables of the latitudes and longitudes so that the respective capturing positions overlap to specify a concentration region of the capturing positions. The altitudes and ranges correspond to densities and band widths in the Kernel density estimation. For example, the capturing position distribution chart illustrated in FIG. 2B is generated from a set of the capturing positions of the still images illustrated in FIG. 2A.

In the capturing position distribution chart, as the number of still images increases, an altitude of a capturing position increases. When the number of captured still images is large, it is considered that a user is interested in the capturing position. Therefore, in the capturing position distribution chart, the altitude of the capturing position may represent a priority for the capturing position.

Basically, as the number of still images increases, a priority for a capturing position increases. The still image additional information interpreting unit 13 may modify an altitude and a range of a capturing position in consideration of various information items on still images as follows.

An altitude is made larger with respect to a more recent capturing date. This is because it is considered that recently captured still images more strongly reflect a user's current taste than previously captured ones do.

An altitude is made larger with respect to higher resolution. This is because it is considered that a still image with high resolution is important to a user.

An altitude is increased when a still image is captured by a high quality device such as a single-lens reflex (SLR) camera and is reduced when the still image is captured by a mobile phone. This is because it is considered that the still image captured by the high quality device is important to a user.

An altitude is made larger as a capturing position is remoter from a position in which a corresponding digital broadcast receiving apparatus is provided (a user's house). This is because, when the capturing position is remote from the user's house, it is very likely that the capturing position is, for example, a travel destination and more strongly reflects a user's taste. In addition, since the number of still images captured near the user's house is inevitably large, it is necessary to prevent an altitude of a capturing position near the user's house from increasing by increasing the altitude of the capturing position remote from the user's house.

An altitude is changed in accordance with a capturing mode. For example, a priority for a landscape mode is increased and that for a fair skin mode is reduced. This is because it is considered that the landscape mode, in which landscape is captured, must have a higher priority than that for the fair skin mode in terms of guessing a user's taste based on a capturing position.

A range is made larger as a focal distance is longer. This is because it is considered that a user's interest is not in a position near a capturing position but is in a certain range from the capturing position.

An altitude is reduced when a focal distance is long and azimuth is uniform. In addition, a capturing position may be biased to a range. This is because, since a user is photographing a specific subject remote from the capturing position, it is considered that a user's interest is in a position remote from the capturing position.

In addition, when it is considered that a subject remote from a focal distance or a capturing position of a still image is photographed, additional information on the still image may be excluded from generation of the capturing position distribution chart. That is, the capturing position distribution chart may be generated by using only additional information on a still image whose capturing position is close to a position of a subject to be photographed.

The capturing position distribution chart generated by the still image additional information interpreting unit 13 is stored in the still image position information accumulating unit 14 as capturing position information. The still image position information accumulating unit 14 may be implemented by a semiconductor memory apparatus or a hard disk apparatus.

The digital broadcast receiving unit 21 receives a digital broadcast wave to divide the received digital broadcast wave into program information items such as an image, voice, data, and an event information table (EIT). The received digital broadcast wave may be one of a ground wave, a BS wave, and a CS wave, a cable television broadcast, or an Internet broadcast. The image voice output unit 22 outputs the divided image and voice and a still image of a data broadcast. The program table display unit 23 forms a program table from the divided program information items to display the program table.

As illustrated in TABLE 2, the program information items include a program name, a broadcast data, and a program content. The program place name information interpreting unit 24 extracts keywords, which may specify geographical position and range, such as a place name and a landmark name from the divided program information items. For example, in an example of the TABLE 2, a place name and landmark names such as “Tokyo Sky Tree”, “Tokyo”, and “Koenji” are extracted.

TABLE 2

| Broadcast date | Program name | Program content |
|---|---|---|
| 2011 Jul. 30 | NHK special “Tokyo Sky | Tokyo Sky Tree that is one |
| 10:05-10:30 | Tree, Challenge to the | of the highest buildings in |
| | World Highest Building” | the world. The first |
| | | challenged high place |
| | | work . . . |
| 2011 Jul. 28 | Small travel “Youth Tokyo | Tokyo Koenji that is a |
| 11:05-11:30 | Station ~ Tokyo Koenji ~” | street on which young |
| | | people gather. Young |
| | | people having dreams . . . |

The keywords extracted by the program place name information interpreting unit 24 are stored in the program place name information accumulating unit 25 as the program name information. The program place name information accumulating unit 25 may be implemented by a semiconductor memory apparatus or a hard disk apparatus.

On the other hand, in the map information accumulating unit 32, map information on geographical position and range of a place name or a landmark is stored. TABLE 3 represents an example of the map information. The map information is formed of place names, positions (latitudes and longitudes), and ranges. The place names represent various positions on a map such as a country name, names of prefectures of Japan, names of municipalities of Japan, tourist spot names, and landmark names.

TABLE 3

| Place name | | | Longitude | Latitude | Range | Class |
|---|---|---|---|---|---|---|
| Tokyo-do | | | 35.6851 | 139.8106 | Within | Prefecture |
| | | | | | 94 km in | |
| | | | | | the east | |
| | | | | | and | |
| | | | | | west | |
| | | | | | Within | |
| | | | | | 23 km in | |
| | | | | | the | |
| | | | | | south | |
| | | | | | and | |
| | | | | | north | |
| | Sumida-ku | | 35.7119 | 139.8023 | Within | Municipality |
| | | | | | 7 km | |
| | | | | | radius | |
| | | Tokyo Sky | 35.42265 | 139.4839 | Within | Famous |
| | | Tree | | | 200 m | place |
| | | | | | radius | |
| | Chiyoda-ku | | 35.6851 | 139.7553 | Within | Municipality |
| | | | | | 7 km | |
| | | | | | radius | |
| | | Tokyo | 35.6815 | 139.7668 | Within | Famous |
| | | station | | | 100 m | place |
| | | | | | radius | |
| Chiba | | | 35.5344 | 140.2459 | Within | Prefecture |
| prefecture | | | | | 40 km in | |
| | | | | | the east | |
| | | | | | and | |
| | | | | | west | |
| | | | | | Within | |
| | | | | | 128 km | |
| | | | | | in the | |
| | | | | | south | |
| | | | | | and | |
| | | | | | north | |
| | | Disneyland | 35.37583 | 139.52493 | Within | Famous |
| | | | | | 500 m | place |
| | | | | | radius | |

Since the place names may point out large ranges such as a country name and names of prefectures of Japan and small ranges such as facility names, the place names may have classified information. For example, the place names may be classified into three of “prefectures of Japan”, “municipalities”, and “famous places” in the order of a range. In addition, the ranges may be specified by polygons or ellipses other than radiuses or lengths in all directions. In addition, the place names may be designated by altitudes.

The map information may be stored in the map information accumulating unit 32 with digital versatile disk (DVD) media interposed. However, since the map information is large and is frequently updated, it is preferable to access a network to refer to, obtain, and update the map information. Therefore, the map information obtaining unit 31 accesses the network to obtain the map information from an arbitrary server. Therefore, it is possible to cope with a rapid increase in the map information and to easily add place names such as new tourist spot names.

The position overlap evaluating unit 33 evaluates a degree of overlap between a map range based on program information and a capturing position range based on additional information on a still image. Specifically, the position overlap evaluating unit 33 obtains a map range corresponding to the keywords stored in the program place name information accumulating unit 25 with reference to the map information stored in the map information accumulating unit 32. In addition, the position overlap evaluating unit 33 obtains a horizontal cross-section obtained by slicing the capturing position distribution chart stored in the still image position information accumulating unit 14 by an arbitrary altitude. The position overlap evaluating unit 33 evaluates an overlap area between the map range and the horizontal cross-section, which is obtained as the degree of overlap.

FIG. 3 is a block diagram illustrating an example of evaluation of an overlap area between a map range based on program information and a horizontal cross-section of a capturing position distribution chart. For example, the map range of within the 200 m radius based on the longitude 35.42265 and the latitude 139.4839 is obtained for the keyword “Tokyo Sky Tree” with reference to the map information. On the other hand, in the case where a significant number of still images captured in Tokyo Sky Tree or near Tokyo Sky Tree are read, when the capturing position distribution chart is sliced, a horizontal cross-section having a certain area may be obtained near Tokyo Sky Tree. The position overlap evaluating unit 33 evaluates an area of an overlap part between the corresponding map range and the corresponding horizontal cross-section.

The recommended program interpreting unit 34 determines a priority for a program in accordance with the overlap area evaluated by the position overlap evaluating unit 33. Specifically, when a ratio of the overlap area evaluated by the position overlap evaluating unit 33 to the area of the map range is larger than a predetermined value, the recommended program interpreting unit 34 sets a priority for a program including a keyword to which the map range corresponds to be high. For example, in the example of FIG. 3, since most of the map range of the keyword “Tokyo Sky Tree” overlaps the horizontal cross-section of the capturing position distribution chart, a priority for the program “Tokyo Sky Tree, Challenge to the World Highest Building” of the TABLE 2 is set to be high.

In addition, the recommended program interpreting unit 34 may more minutely set a priority for a program as follows.

As a map range to be evaluated by the position overlap evaluating unit 33 is smaller, that is, as an area of a map range is smaller, a priority is set to be higher. This is because it is considered that a small map range, for example, “Tokyo Sky Tree” may more appropriately specify a place or a facility in which a user is interested than a large map range, for example, “Tokyo” does.

As a capturing position range to be evaluated by the position overlap evaluating unit 33 has a higher priority determined by the still image additional information interpreting unit 13, that is, as an altitude of a horizontal cross-section is higher, a priority is set to be higher. This is because the altitude represents a priority for a capturing position and the priority for the capturing position is higher as the altitude is higher.

Specifically, the altitude of the horizontal cross-section of the capturing position distribution chart is sequentially reduced to find a map range that satisfies the above conditions and a priority for a program corresponding to the map range is set in the order of finding the map range to set the above-described program priority.

The recommended program notifying unit 35 receives the interpretation result of the recommended program interpreting unit 34 to generate a user interface for recommending a program, for which a priority is set to be high (hereinafter, referred to as a recommended program). The user interface may be obtained by marking priorities for programs in a conventional program table or may be a program map completely different from the conventional program table. The program map is obtained by linking program information of a recommended program to a map image.

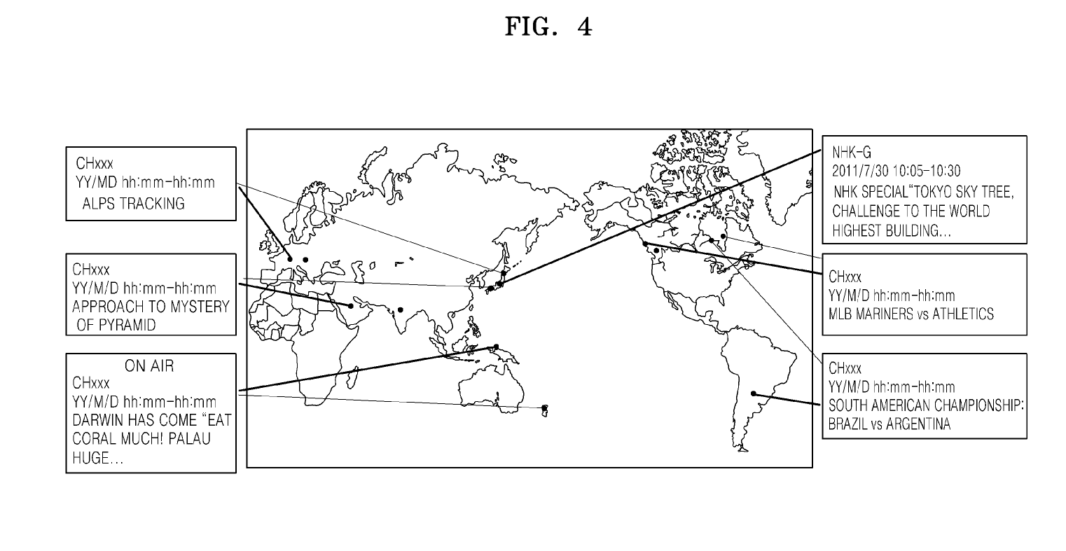

FIG. 4 is a view illustrating an example in which a program map is displayed on a screen. For example, program information on several recommended programs is displayed on a world map to indicate positions related to the programs. A user may select the program information of the suggested recommended programs to perform programmed recording on the programs or to watch the programs. A method of displaying program information may be changed in accordance with a difference in priorities for programs or broadcast dates of programs.

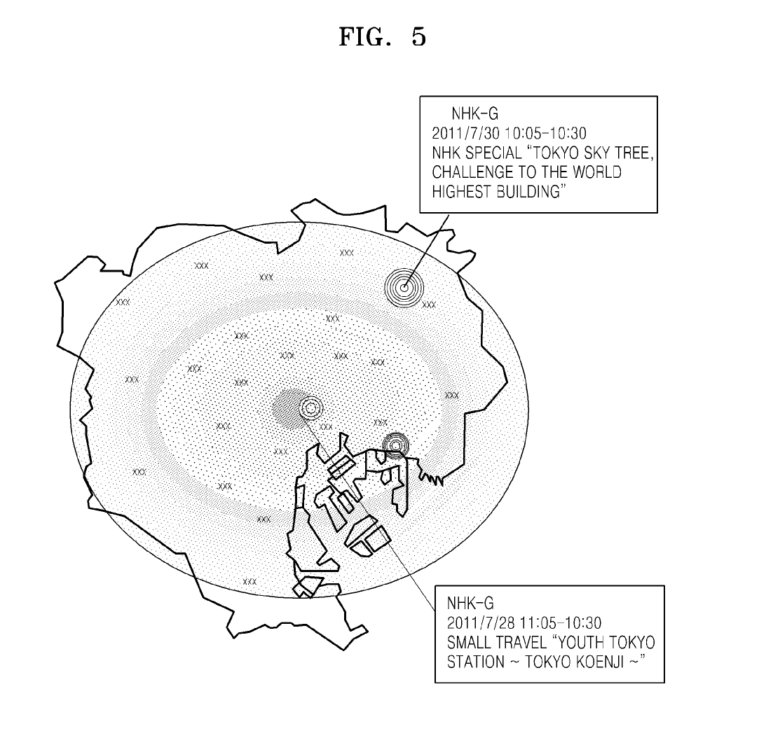

The program map may be enlarged or reduced. FIG. 5 is a view illustrating an example in which a program map is displayed on a screen when a vicinity of Tokyo is enlarged. As illustrated in the example of FIG. 5, priorities for capturing positions determined by the still image additional information interpreting unit 13, that is, the capturing position distribution chart may be displayed to be gradated and overlapped on the program map.

On the other hand, the above-described embodiments of the present invention may be made as a program executable in a computer and may be implemented by a general-purpose digital computer that operates the program by using a computer readable recording medium. The computer readable recording medium may be a magnetic storage medium such as a read only memory (ROM), a floppy disk, and a hard disk, an optical reading medium such as a compact disc read only memory (CD-ROM) and a digital versatile disk (DVD), or carrier waves such as transmission through the Internet.

### INDUSTRIAL APPLICABILITY

Since the digital broadcast receiving apparatus according to the present invention may recommend a program to sufficiently reflect a user's taste based on capturing position information of still images, the digital broadcast receiving apparatus is useful to a digital television set or a set-top box that may read still images.

1. A digital broadcast receiving apparatus comprising:
a still image additional information interpreting unit for collectively determining a priority for a capturing position of a still image based on additional information on the still image;
a program place name information interpreting unit for extracting a keyword that specifies a geographical position or a range from program information of a digital broadcast;
a position overlap evaluating unit for obtaining a map range corresponding to the extracted keyword with reference to map information on the geographical position and the range and evaluating a degree of overlap between the map range and a capturing position range having a predetermined priority which is predetermined by the still image additional information interpreting unit;
a recommended program interpreting unit for setting a priority for a program including the keyword to which the map range corresponds when the degree of overlap is larger than a predetermined value; and
a recommended program notifying unit for generating a user interface for recommending the program for which the priority is set.

2. The digital broadcast receiving apparatus of claim 1, wherein the recommended program interpreting unit sets a priority for a program to be higher as a map range to be evaluated by the position overlap evaluating unit becomes smaller.

3. The digital broadcast receiving apparatus of claim 1, wherein the recommended program interpreting unit sets a priority for a program to be higher as the predetermined priority determined by the still image additional information interpreting unit for a capturing position range to be evaluated by the position overlap evaluating unit becomes higher.

4. The digital broadcast receiving apparatus of claim 1, further comprising a map information obtaining unit for accessing a network to obtain the map information.

5. The digital broadcast receiving apparatus of claim 1, wherein the recommended program notifying unit links program information of a program having a high priority to a map image by the user interface to generate a program map.

6. The digital broadcast receiving apparatus of claim 5, wherein the priority for the capturing position determined by the still image additional information interpreting unit is displayed to be gradated and overlapped on the program map.

7. A digital broadcast receiving method comprising:
collectively determining a priority for a capturing position of a still image based on additional information on the still image;
extracting a keyword that specifies a geographical position or a range from program information of a digital broadcast;
obtaining a map range corresponding to the extracted keyword with reference to map information on the geographical position and the range and evaluating a degree of overlap between the map range and a capturing position range having a predetermined priority;
setting a priority for a program including the keyword to which the map range corresponds to be high when the degree of overlap is larger than a predetermined value; and
generating a user interface for recommending the program for which the priority is set to be high.

8. The digital broadcast receiving method of claim 7, wherein, in the setting of the priority for the program including the keyword corresponding to the map range to be high when the degree of overlap is larger than the predetermined value, a priority for a program is set to be higher as a map range to be evaluated becomes smaller.

9. The digital broadcast receiving method of claim 7, wherein, in the setting of the priority for the program including the keyword corresponding to the map range to be high when the degree of overlap is larger than the predetermined value, a priority for a program is set to be higher as the predetermined priority for a capturing position range to be evaluated becomes higher.

10. The digital broadcast receiving method of claim 7, wherein, in the generating of the user interface for recommending the program for which the priority is set to be high, program information of the program, for which the priority is set to be high, is linked to a map image by the user interface to generate a program map.

11. The digital broadcast receiving method of claim 10, wherein the priority for the capturing position is displayed to be gradated and overlapped on the program map.
